(19) United States
(12) Patent Application Publication
(10) Pub. No.: US 2013/0183221 A1
(43) Pub. Date: Jul. 18, 2013

(54) PREPARATION OF COPPER OXIDE-CERIUM OXIDE-SUPPORTED NANO-GOLD CATALYSTS AND ITS APPLICATION IN REMOVAL OF CARBON MONOXIDE IN HYDROGEN STREAM

(71) Applicant: NATIONAL CENTRAL UNIVERSITY, Jhongli City (TW)

(72) Inventors: Yu-Wen CHEN, Jhongli City (TW); Wen-Ching CHENG, Jhongli City (TW)

(73) Assignee: NATIONAL CENTRAL UNIVERSITY, Jhongli City (TW)

(21) Appl. No.: 13/739,641

(22) Filed: Jan. 11, 2013

(30) Foreign Application Priority Data
Jan. 13, 2012 (TW) 101101431

(51) Int. Cl. B01J 23/89; B01D 53/00

(52) U.S. Cl. CPC B01J 23/894; B01D 53/00
USPC 423/247; 502/304

(57) ABSTRACT

A preparation method of nano-gold catalysts supported on copper oxide-cerium oxide (CuO—CeO₂) and a process of preferential oxidation of carbon monoxide by oxygen in hydrogen stream with the nano-gold catalysts are disclosed. CuO—CeO₂ is prepared by either coprecipitation or incipient-wetness impregnation method, and gold is deposited thereon by deposition-precipitation. After adding CuO into Au/CeO₂, the interaction between the nano-gold and the support is increased, thereby enhancing the stability of the gold particle and the activity of the catalysts. Preferential oxidation of CO in hydrogen stream (with O₂ existing) over these catalysts is carried out in a fixed bed reactor. The O₂/CO ratio should be between 0.5 and 4. The catalyst is applied to remove CO (to lower than 10 ppm) in hydrogen stream in fuel cell to prevent from poisoning of the electrode of the fuel cell.

### CROSS REFERENCE TO RELATED APPLICATIONS

This Non-provisional application claims priority under 35 U.S.C. §119(a) on Patent Application No(s). 101101431 filed in Taiwan, Republic of China on Jan. 13, 2012, the entire contents of which are hereby incorporated by reference.

### BACKGROUND OF THE INVENTION

1. Field of Invention

The present invention relates to a preparation method of nano-gold catalysts supported on copper oxide-cerium oxide (CuO—CeO₂) and a process of preferential oxidation of carbon monoxide by oxygen in hydrogen stream with the nano-gold catalysts. The catalyst is applied to remove CO (to lower than 10 ppm) in hydrogen stream in fuel cell to prevent from poisoning of the electrode of the fuel cell. The present invention can also be applied to remove CO from hydrogen stream for increasing hydrogen purity in the tank.

2. Related Art

Many researches are focused on new energy sources and effective usage and storage thereof. Regarding to this, the fuel cell that can transform chemical energy into electricity in high efficiency and easily store energy is a potential technology. The current fuel cells are generally classified by operation temperature into the high-temperature fuel cells (operation temperature higher than 650° C.) and the low-temperature fuel cells (operation temperature lower than 250° C.). Among these fuel cells, the low-temperature fuel cell is much safer and has smaller size, so it is more popular. However, the electrode of these fuel cells can be easily poisoned by carbon monoxide (CO). For example, the maximum allowable quantity of CO in the phosphoric acid fuel cell (PAFC) is 2%, and that of the proton exchange membrane (PEM) fuel cell is only several ppm. Accordingly, it is a very important issue of the fuel cell technology to obtain the clean hydrogen source.

The hydrogen for fuel cells is usually collected by steam reforming of methane and moisture, which is the most economic hydrogen source. However, the steam reforming of methane and moisture needs a series of hydrogen purification processes. Otherwise, hydrogen can also be collected by decomposition of other hydrocarbon compounds or ammonia. To be noted, the decomposition of ammonia will not generate the side product of CO. The steam reforming of methane and moisture will definitely generate the side product of CO, which is the major factor for decreasing the efficiency of electrode. Thus, the collected hydrogen must be treated with a serial of CO removal procedures and then is allowed to be introduced into the fuel cell. The serial of CO removal procedures will be described hereinafter. First, the high-temperature moisture is applied to react with CO at 350-500° C. in a water gas shift (WGS) reactor. In this procedure, a mixture catalyst of FeO—Cr₂O₃ is used to decrease the concentration of CO to less than 3%. Then, after a low-temperature water-gas shift reaction (200-300° C.) with the catalyst of CuO/ZnO/Al₂O₃, the concentration of CO can be further decreased to less than 1%. Finally, a CO oxidation is selectively performed in a preferential oxidation reactor (PROX) to decrease to concentration of CO to less than 5 ppm. PROX is one of the most effective CO removal methods. The common catalyst for this reaction is for example Pt which has superior oxidation ability for CO and hydrogen. Although the Pt catalyst has good reaction activity, it has increasing oxidation to hydrogen. That is, when the reaction temperature increases, the conversion rate of CO as well as the selectivity of CO will be decreased. Regarding to the Pt catalyst, the moisture contained in the raw material does not affect the reaction obviously. Alternatively, the reaction may also use other metal catalyst such as Ru, Rh, Pd or the likes, and the conversion rate of CO with any of these metal catalysts is similarly decreased as the temperature increases. In the prior researches, gold is defined as an inactive inertia metal. Recently, Haruta have found that the nano-gold carried on the metal support can express a high activity, which can catalyze the oxidation of CO at a low-temperature environment. After this significant discovery, the application of gold catalyst has become more and more important.

The activity of gold catalyst may vary depending on the preparation method, gold particle size, gold shape, reaction conditions, and support. The deposition-precipitation method is the simplest method for preparing gold catalyst, and this method can produce the gold catalyst with gold particles of 2-5 nm and evenly distributed on the support by properly controlling the concentration of precursor and the calcine temperature. However, the deposition-precipitation method usually uses the low-concentration gold solution to prevent gold particle accumulation, so the actual amount (about 50-60%) of gold particles carried on the support is insufficient.

Oh and Sinketvitch et al. also disclosed to use other metal catalyst such as Ru, Rh or Pd for this reaction (Journal of Catalysis, Vol. 142, 1993, pages 254-262). By using Ru, Rh or Pd as the catalyst, the conversion rate of CO is also decreased as the temperature increases. The decreases of the conversion rates of different catalysts (0.5%) are as the following relationships: Ru/Al₂O₃>Rh/Al₂O₃>Pt/Al₂O₃>Pd/Al₂O₃. In addition, Matralis et al. also disclosed the PROX reactions at the reaction temperature between 25 and 250° C. with three catalysts of 5 wt. % Pt/γ-Al₂O₃, 2.9 wt. % Au/α-Fe₂O₃, and CuO—CeO₂. Matralis et al. found that the gold catalyst is suitable for the reaction at the temperature less than 100° C., the copper catalyst is suitable for the reaction at the temperature between 100 and 200° C., and the Pt catalyst has a 100% CO conversion rate at 200° C. Besides, it is also found that the existing of CO₂ in the reaction gas will decrease the conversion rate of CO, which is much obvious for the case using gold catalyst. Compared with Pt catalyst, gold catalyst has higher activity at the temperature less than 100° C., which is much superier than any other metal catalyst. Besides, the price of gold is cheaper than platinum, and the operation temperature of gold catalyst is more suitable for the low-temperature fuel cell while additional heating process is unnecessary.

Some disclosures related to gold catalyst is applied to oxidation of CO and never taught to use copper oxide-cerium oxide (CuO—CeO₂) as a support and to induce the reaction under 100° C. or less. The published references never disclose the feature of the present invention that uses nano-gold catalysts supported on CuO—CeO₂ to preferential oxidize CO.

Some other disclosures taught to use Pt, Ru, Rh, and their alloys as catalyst to preferential oxidize CO. Compared with these conventional catalysts, the catalyst of the present invention is much cheaper. Besides, when using nano-gold catalysts supported on CuO—CeO₂ to preferential oxidize CO, the selectivity and conversion rate of CO oxidation can be enhanced and hydrogen oxidation can be simultaneously inhibited. Moreover, the nano-gold catalysts can be operated at the temperature less than 100° C. with high activity. A JP patent publication No. JP2004-338981 (Dec. 2, 2004) discloses a hydrogen purifying apparatus, its operation method, and manufacturing method of carbon monoxide selective oxidation catalyst. In this reference, the catalyst (e.g. Pt, Rh, or Pt—Rh alloy) is loaded on the oxide support (e.g. aluminum oxide), and it is used to selectively remove CO from hydrogen reform gas at a temperature of 200˜350° C. However, the disclosed catalyst of this reference needs higher reaction temperature. A JP patent publication No. JP2004-284920 (Oct. 14, 2004) discloses a selective oxidation reaction device, and method for removing carbon monoxide using the same. In this reference, a selective oxidation reaction device containing two catalyst parts is used to remove CO from hydrogen reform gas. The catalysts (Pt and Ru) are loaded on the metal oxide support such as aluminum oxide or silicon oxide. A U.S. Pat. No. 6,787,118 (Sep. 7, 2004) discloses a selective removal of carbon monoxide, wherein the catalysts (e.g. Pt, Pd, Au) are loaded on the oxide mixture made by coprecipitation and containing Ce and other metals (e.g. Zr, Fe, Mn, Cu). A U.S. Pat. No. 6,780,386 (Aug. 24, 2004) discloses a carbon monoxide oxidation catalyst, and a method for production of hydrogen-containing gas. In this patent, the catalyst (Ru) is loaded on titanium oxide and aluminum oxide and can decreases the concentration of CO in a hydrogen-rich gas from 0.6% to about 10 ppm. A JP patent publication No. JP2004-223415 (Aug. 12, 2004) discloses a catalyst for selective oxidation of carbon monoxide, method for decreasing carbon monoxide concentration, and fuel cell system. In the embodiment of this reference, the catalyst (Ru) is loaded on aluminum oxide and can decrease the concentration of CO in a hydrogen-rich gas from 6000 ppm to less than 10 ppm. U.S. Pat. No. 6,673,742 (Jan. 6, 2004) and U.S. Pat. No. 6,409,939 (Jan. 25, 2002) disclose a method for producing a preferential oxidation catalyst and a method for producing a hydrogen-rich fuel stream. The produced catalyst (0.5˜3% Ru/Al₂O₃) can preferentially oxidize CO (0.47%) in a hydrogen-rich stream at a temperature of 70˜130° C., so that the concentration of CO in the treated gas is decreased to 50 ppm. A U.S. Pat. No. 6,559,094 (May 6, 2003) discloses a method for preparation of catalytic material for selective oxidation and catalyst members thereof, wherein a typical catalyst (5% Pt-0.3% Fe/Al₂O₃) is used. A U.S. Pat. No. 6,531,106 (Mar. 11, 2003) discloses a selective removing method of carbon monoxide, wherein the catalyst (precious metal such as Pt, Pd, Ru, Rh, or Ir) is loaded on crystalline silicate. In the embodiment of this patent, the gas containing 0.6% CO, 24% CO₂, 20% H₂O, 0.6% O₂, and 54.8% H₂ is treated, and the concentration of CO can be decreased to less than 50 ppm at different reaction temperatures. A JP patent publication No. JP2003-104703 (Apr. 9, 2003) discloses a method for lowering carbon monoxide concentration and a fuel cell system. In the embodiment of this reference, the Ru—Pt/Al₂O₃ catalyst is prepared and can decrease the concentration of CO in a hydrogen-contained reform gas from 6000 ppm to 4 ppm. U.S. Pat. No. 6,287,529 (Sep. 11, 2001) and U.S. Pat. No. 5,874,041 (Feb. 23, 1999) disclose a method and device for selective catalytic oxidation of carbon monoxide. The device is a multistage CO-oxidation reactor with the catalyst of Pt or Ru loaded on Al₂O₃ or zeolite for decreasing the concentration of CO in a hydrogen-rich steam to less than 40 ppm. A JP patent publication No. JP2000-169107 (Jun. 20, 2000) discloses a production of hydrogen-containing gas reduced in carbon monoxide. In the embodiment of this reference, the catalyst is prepared by carrying Ru and an alkali metal and/or an alkaline earth metal on a titanium oxide and aluminum oxide carrier, and can decrease the concentration of CO in a hydrogen-containing gas from 0.6% to less than 50 ppm at a temperature of 60˜160° C. An EP patent No. EP0955351 (Nov. 10, 1999) and a JP patent publication No. JP11310402 (Nov. 9, 1999) disclose a carbon monoxide concentration reducing system and production of carbon monoxide selectively oxidative catalyst. The catalyst is produced by disposing Pt and Ru in different ratios on Al₂O₃, and the ratios of Pt to Ru can change the temperature of the selectively oxidation reaction. A U.S. Pat. No. 5,258,340 (Nov. 2, 1993) discloses mixed transition metal oxide catalysts for conversion of carbon monoxide and method for producing the catalysts. The catalysts of this invention are prepared by using a sequential precipitation process to generate substantially layered metal oxides including the inner cobalt oxide layer and outer oxide layer (containing Fe, Ni, Cu, Zn, Mo, W, or Sn). The layered metal oxides can also be supported by silicon dioxide support. Finally, the noble metal such as Au, Pt, Pd, Rh or their combinations is loaded on the layered metal oxides so as to preparing the catalysts. The prepared catalysts are applied to CO oxidation at low-temperature. The embodiments 1-2 show that T₅₀ (required temperature for reaching 50% CO conversion rate) varies (46˜240° C.) depending on the components of the catalysts. A JP patent publication No. JP05201702 (Aug. 10, 1993) discloses a method and apparatus for selectively removing carbon monoxide, which uses Ru/Al₂O₃ and Rh/Al₂O₃ as the catalysts at a temperature less than 120° C. for decreasing the CO concentration in hydrogen-containing gas to less than 0.01%.

### SUMMARY OF THE INVENTION

The present invention discloses a preparation method of nano-gold catalysts supported on copper oxide-cerium oxide (CuO—CeO₂) and a process of preferential oxidation of carbon monoxide by oxygen in hydrogen-rich stream with the nano-gold catalysts supported on CuO—CeO₂ are disclosed. CuO and CeO₂ are mixed in different ratios, and the supported gold particles are smaller than 5 nm. Preferential oxidation of CO in hydrogen stream (also containing CO, O₂ and He) over these catalysts is carried out in a continuous-type packed bed reactor. The catalyst is applied to remove CO (to lower than 10 ppm) in fuel cell to prevent from poisoning of the electrode of the fuel cell.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a TEM image of Au/CuOₓ—CeO₂ catalyst (coprecipitation) and a graph showing the size distribution of gold particles, wherein the average gold particle size is 3.09 nm;

FIG. 2 is a XRD graph of gold catalystes containing Cu:Ce of different ratios, wherein (a) represents Au/CeO₂, (b) represents Au/CuOₓ—CeO₂ (IMP 5:95), (c) represents Au/CuOₓ—CeO₂ (IMP 1:9), (d) represents Au/CuOₓ—CeO₂ (CP 5:95), and (e) represents Au/CuOₓ—CeO₂ (CP 1:9) (Cu:Ce by atom ratio);

FIG. 3 shows Au 4f XPS spectrums for Au/CuOₓ—CeO₂ catalysts with different Cu/Ce ratios, wherein (a) IMP 5:95, (b) IMP 1:9, (c) CP 5:95, and (d) CP 1:9;

FIG. 4 is a graph showing conversion rates by using different Au/CuOₓ—CeO₂ gold catalysts, which are prepared by different methods and/or have different Cu/Ce ratios; and

FIG. 5 is a graph showing reaction selective rates by using different Au/CuOₓ—CeO₂ gold catalysts, which are prepared by different methods and/or have different Cu/Ce ratios.

### DETAILED DESCRIPTION OF THE INVENTION

The present invention will be apparent from the following detailed description, which proceeds with reference to the accompanying drawings, wherein the same references relate to the same elements.

### First Embodiment

Copper oxide-cerium oxide (CuO—CeO₂) is prepared by coprecipitation and is used as a support for gold. In detailed, copper nitriate and cerium nitriate powders are added into water to form a solution. Ammonia water is slowly added to precipitate CuO—CeO₂. The CuO—CeO₂ precipitate is calcined in air at any temperature between 200° C. and 400° C. for 2-10 hours, and the calcined CuO—CeO₂ precipitate is ground to obtain CuO—CeO₂ powder.

### Second Embodiment

Copper oxide-cerium oxide (CuO—CeO₂) is prepared by incipient-wetness impregnation and is used as a support for gold. This step can prepare the mixture support with different atom ratios. In detailed, copper nitriate powder is added into water to form a solution. The copper nitriate solution is dropped into CeO₂ and then stirred. The mixture is calcined in air at a temperature between 200° C. and 400° C. for 2-10 hours to obtain CuO—CeO₂ powder.

### Third Embodiment

Gold particles are deposited on the prepared oxide support of CuO—CeO₂ by deposition-precipitation method. In detailed, tetrachloroauric acid (1 wt. % Au) is provided to form a gold solution (1×10⁻³ M-5×10⁻³ M), which is then added to the support solution. The solution is controlled at the pH value between 7 and 9 by ammonia water, and at a temperature between 50° C. and 80° C. The solution is filtered, and the filter cake is washed by distilled water to remove chlorine, dried at any temperature between 60° C. and 100° C. for 2-20 hours, and calcined at any temperature between 100° C. and 200° C. Then, the desired catalysts are prepared.

### Example 1

Copper oxide-cerium oxide (CuO—CeO₂) is prepared by coprecipitation and is used as a support for gold. In practice, copper nitriate and cerium nitriate powders are added into water to form a solution. Ammonia water is slowly added to precipitate CuO—CeO₂. The CuO—CeO₂ precipitate is calcined in air at 300° C. for 4 hours, and the calcined CuO—CeO₂ precipitate is ground to obtain CuO—CeO₂ powder. Gold particles are deposited on the prepared oxide support of CuO—CeO₂ by deposition-precipitation method. In practice, tetrachloroauric acid (1 wt. % Au) is provided to form a gold solution (2×10⁻³M), which is then dropped into the support solution. The solution is controlled at the pH value of 7 by ammonia water, and at a temperature of 65° C. The solution is filtered, and the filter cake is washed by distilled water to remove chlorine, dried at 100° C. for 5 hours, and calcined at 180° C., thereby obtaining the desired catalysts.

The crystal phase of the prepared catalysts is determined by an X-ray diffractometer (XRD), the particle size of gold is observed by a transmission electron microscope, the electronic state of gold is measured by an electron spectroscopy for chemical analysis system.

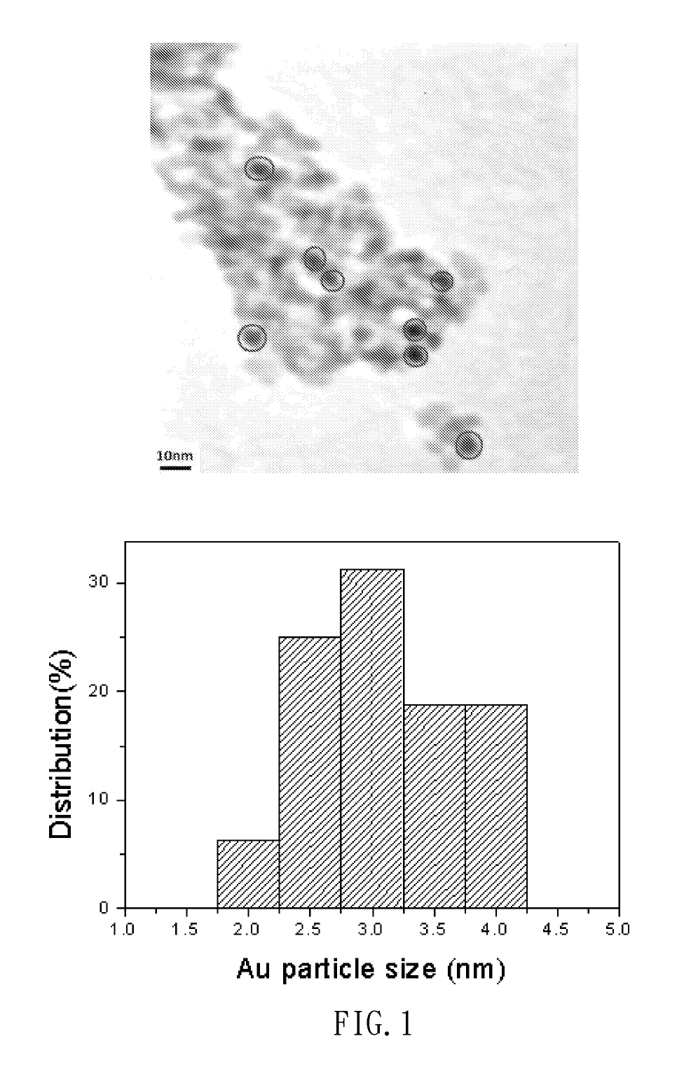

The transmission electron microscope can observe the catalyst shape, particle size, and particle diameter distribution. FIG. 1 shows the Au/CuO—CeO₂ catalysts prepared by deposition-precipitation method, wherein the average particle diameter is 3.09 nm, and the diameter of most particles is about 3 nm. The observed dark spots represent the semi-spherical nano-gold, which is distributed on the CuO—CeO₂ support. This observed result matches the gold characteristic peaks that can not be detected by XRD.

X-Ray Diffractometer

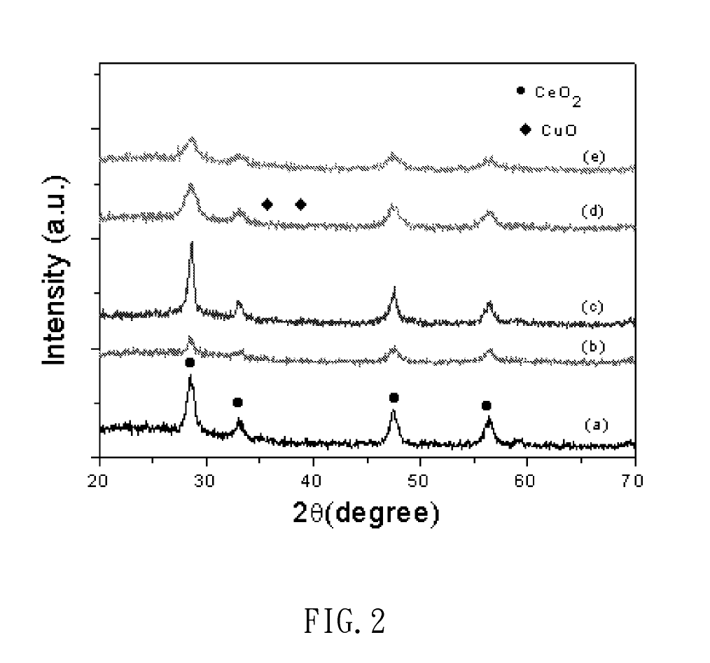

The X-ray diffractometer (XRD) is used to detect the crystal phase of the catalysts. FIG. 2 shows the XRD patterns of the gold catalystes containing Cu:Ce of different ratios. Herein, (a) represents Au/CeO₂, (b) represents Au/CuOₓ—CeO₂ (IMP 5:95), (c) represents Au/CuOₓ—CeO₂ (IMP 1:9), (d) represents Au/CuOₓ—CeO₂ (CP 5:95), and (e) represents Au/CuOₓ—CeO₂ (CP 1:9) (Cu:Ce by atom ratio). Referring to FIG. 2, it is obvious that the characteristic peaks of CeO₂ are 20=28.55° (111), 33.07° (200), 47.48° (220), 56.34 (311). Besides, the characteristic peaks of CuOₓ are much weaker, which means CuOₓ has good distribution on the surface of CeO₂ support and has amorphous structure.

Regarding to all catalysts, the characteristic peak of gold is not found at any possible position where 20 is 38.18° (111), 44.39° (200), 64.58° (220), 77.55° (311). This result proves that the particle size of gold is smaller than 4 nm.

X-Ray Photoelectron Spectroscope

The binding energy of gold particles in the gold catalysts is measured by an X-ray photoelectron spectroscope (XPS). In this example, all spectra are calibrated by the binding energy of C₁ₛ (284.5 eV). Analyzing the peaks, the chemical status of the studied gold includes the atomic gold (Au⁰) and Au⁺, and the quantitative of gold mainly refers to the electron transitions of 4f_{5/2} and 4f_{7/2}. Herein, the binding energy of Au⁰ is located at 83.9 eV and 87.57 eV, and the binding energy of Au⁺ is located at 88.2 eV and 84.7 eV. The analysis results of the surface composition of gold are shown in the following Table 1.

TABLE 1
Compositions of oxidized gold in the gold catalysts

| | | |
|---|---|---|
| | | Composition |
| | | ratio of the |
| | | surface atom |
| Preparation | Cu:Ce | (%) |

| Catalyst | method | Atom ratio | Au⁰ | Au⁺ |
|---|---|---|---|---|
| Au/CuOₓ—CeO₂ | IMP | 5:95 | 46.68 | 53.32 |
| Au/CuOₓ—CeO₂ | IMP | 1:9 | 72.09 | 27.91 |
| Au/CuOₓ—CeO₂ | CP | 5:95 | 50.28 | 49.72 |
| Au/CuOₓ—CeO₂ | CP | 1:9 | 40.82 | 59.18 |

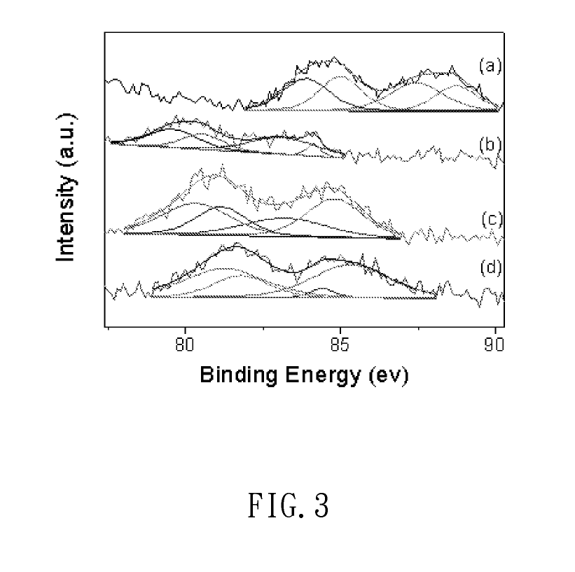

The X-ray photoelectron spectroscope (XPS) can analyze and obtain the surface status of gold catalyst on the CuOₓ—CeO₂ support. The XPS spectra can help us to realize different gold species (Au⁰ and Au⁺) on the catalysts, such as Au 4f_{7/2} and Au 4f_{5/2}. The peaks of Au⁰ are concentrated at 84.0 eV (Au 4f_{7/2}) and 87.7 eV (Au 4f_{5/2}), and the peaks of Au⁺ are concentrated at 86.3 eV (Au 4f_{7/2}) and 89.6 eV (Au 4f_{5/2}). FIG. 3 shows that the gold catalysts have binding energy shift of Au 4f in the XPS spectra, which means that the gold supported on CuOₓ—CeO₂ has very strong metal-support interactions.

### Fourth Embodiment

The prepared catalysts are loaded in the vertical packed-bed reactor for performing preferential oxidation of carbon monoxide in hydrogen-rich gas. The fixed bed reactor is used, wherein the feed gas contains CO/O₂ (1/3) and excess hydrogen.

### Example 2

0.10 g catalyst powder is loaded in the vertical packed-bed reactor for performing preferential oxidation of carbon monoxide in hydrogen-rich gas. The fixed bed reactor is used for this experiment, wherein the outer diameter and inner diameter of the reactor are 1.2 cm and 0.6 cm, and the length of the reactor is 57 cm. 0.7 cm of fused quartz is packed in the reactor for carrying the catalysts and allowing gas to pass through. In addition, a bottom-sealed glass tube with the outer and inner diameters of 0.6 cm and 0.4 cm is inserted into the reactor. The glass tube is configured for receiving a thermocouple, which is used to measure the temperature of the catalysts. When the feed gas contains CO/O₂ of 1/1, the volume ratio of CO/O₂/H₂/He is 1.33/1.33/65.33/32.01. The total flow rate of the mixture gas is about 50 mL/min (controlled by a mass flow controller). The mixture gas is fed into the reactor at room temperature, and the product compound is analyzed by gas chromatography (China Gas Chromatography Company, mode no. 9800T) using a 3.5 m length stainless steel packed column packed with molecular sieve 5A. The temperature of the reactor is controlled by a cylindrical heater with a thermocouple. The heater has an outer length of about 17 cm and an outer diameter of about 11 cm, and includes a thermal insulation device containing 4 cm glass fibers therein. The temperature of the reactor increases from 25° C. with the heating rate of 2° C./min, is held for 10 minutes, respectively, at 35, 50, 65, 80 and 100° C. The sampling processes are made after reaching these temperatures for 5 minutes.

In the selectively oxidation, the flow rate of the gas containing CO (1.33%), O₂ (1.33%), H₂ (65.33%) and He (36%) is about 30,000 h⁻¹. The conversion of CO is defined as: ((CO concentration in input gas)−(CO concentration in output gas))÷(CO concentration in input gas), and the selectivity of CO oxidation is defined as: (O₂ required for CO oxidation)÷((O₂ concentration in input gas)−(O₂ concentration in output gas)). The compositions of CO and O₂ with different ratios are provided while the total flow rate is remained the same.

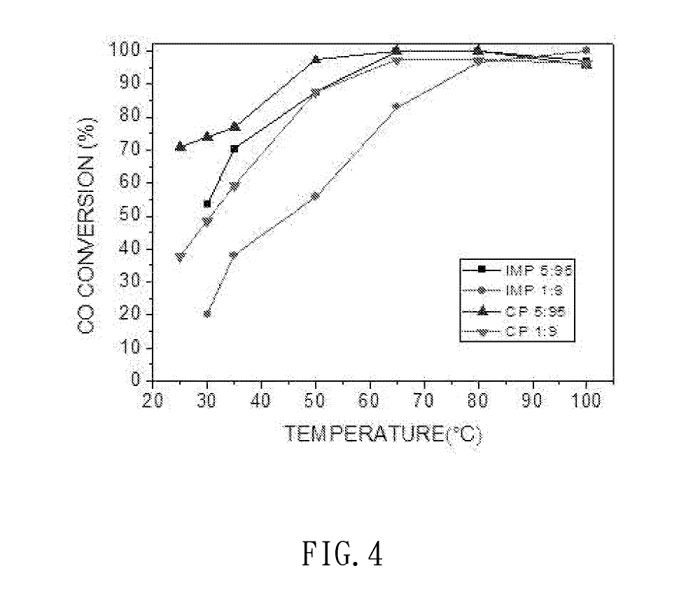

FIG. 4 is a graph showing the selective CO oxidation results as using catalysts with different mole ratios of Cu/Ce. The results show that CO conversion can be improved by adding a proper amount of CuOₓ. For example, the CO conversion at the reaction temperature between 65 and 80° C. reaches 100%; otherwise, the conversion at the reaction temperature of 100° C. also reaches 95% or more. In summary, the catalyst of Au/CuOₓ—CeO₂ (coprecipitation, Cu:Ce=5:95) provides the highest activity, and the catalyst of Au/CuOₓ—CeO₂ (incipient-wetness impregnation, Cu:Ce=1:9) has a higher activity at higher temperature (reaching 100% at 100° C.).

At the reaction temperature of 80° C., all of the catalysts of the invention can reach a CO conversion more than 96%. As the temperature increases, the selectivity for CO oxidation decreases, which means CO and H₂ are competitively absorbed and oxidized by oxygen.

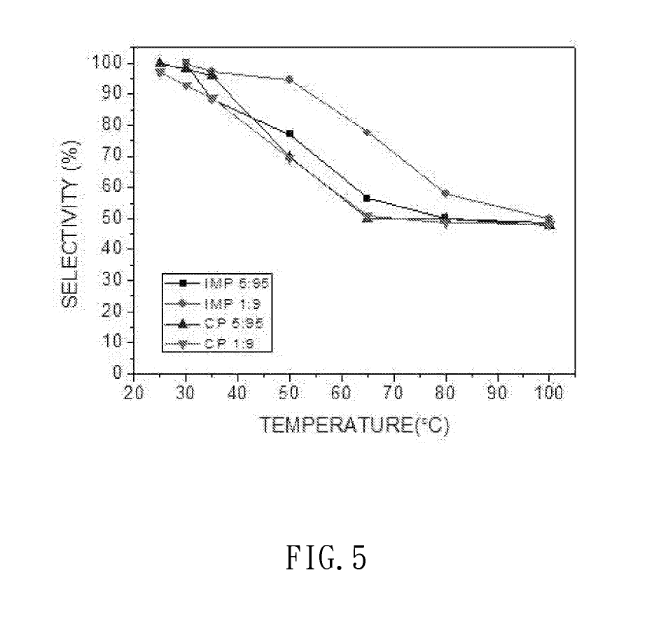

The above-mentioned reactions and results are shown in FIGS. 4 and 5. When the reaction temperature is higher than 80° C., the CO concentration in the outlet gas from the reactor is less than 10 ppm. These experimental results prove that the catalysts of the invention can effectively remove CO from the targeted gas.

In addition, to add a proper amount of CuOₓ on Au/CeO₂ can increase the CO conversion and inhibit oxidation of hydrogen. In more detailed, after adding CuOₓ on Au/CeO₂, the interaction between nano-gold and support can be increased, and the stability of gold particles can be enhanced, thereby improving the activity of the catalysts.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A preparation method of nano-gold catalysts supported on copper oxide-cerium oxide (CuO—CeO₂), comprising steps of:
preparing copper oxide-cerium (CuO—CeO₂) by impregnation method or coprecipitation method;
preparing an oxide support of CuO—CeO₂ by coprecipitation method or incipient-wetness impregnation method, wherein in the coprecipitation method, copper nitriate and cerium nitriate powders are added into water to form a solution, ammonia water is slowly added to precipitate CuO—CeO₂, the CuO—CeO₂ precipitate is calcined in air at a temperature between 200° C. and 400° C. for 2-10 hours; and the calcined CuO—CeO₂ precipitate is ground to obtain CuO—CeO₂ powder; or in the incipient-wetness impregnation method, copper nitriate powder is added into water to form a solution, the copper nitriate solution is dropped into CeO₂ and then stirred, the mixture is calcined in air at a temperature between 200° C. and 400° C. for 2-10 hours to obtain CuO—CeO₂ powder; and
depositing gold particles on the oxide support of CuO—CeO₂ by deposition-precipitation method, wherein gold solution and CuO—CeO₂ are added into water, the solution is controlled at the pH value between 7 and 9 by ammonia water, stirred for 1-10 hours at a temperature between 50° C. and 70° C., washed by distilled water between 50° C. and 70° C., dried between 60° C. and 80° C. for 12 hours, and calcined between 120° C. and 200° C. for 2-10 hours, the ratio of copper to cerium in the CuO—CeO₂ is between 1/99 and 50/50, the weight percentage of gold is between 0.5% and 2%, and the particle size of gold is between 1 and 5 nm.

2. A method of removing carbon monoxide (CO) from a gas stream, comprising step of:
applying nano-gold catalysts supported by CuO—CeO₂ of claim 1 to the gas stream containing hydrogen to oxidize the CO into carbon dioxide (CO₂) at a temperature between 20° C. and 200° C., wherein the reaction gas containing oxygen, CO, and hydrogen, the mole ratio of O₂/CO is between 1 and 4.
